(19) United States
(12) Patent Application Publication
(10) Pub. No.: US 2002/0113797 A1
(43) Pub. Date: Aug. 22, 2002

(54) Systems and methods for representing and displaying graphics

(76) Inventors: Scott T. Potter, Norwalk, CT (US); Murray Levine, Fairfield, CT (US)

Correspondence Address: FISH & NEAVE, 1251 AVENUE OF THE AMERICAS, 50TH FLOOR, NEW YORK, NY, 10020-1105, US

(21) Appl. No.: 09/988,867

(22) Filed: Nov. 16, 2001

Related U.S. Application Data
(60) Provisional application No. 60/249,840, filed on Nov. 17, 2000.

(51) Int. Cl. G09G 5/00

(52) U.S. Cl. 345/581

(57) ABSTRACT

Systems and methods for representing and displaying graphical images that tend to minimize the storage and processing requirements for representing such images on devices with limited storage capacity and processing power are provided. Graphical images may be represented and displayed using the follow techniques: the use of vector shapes and bitmap brushes, primitive shape descriptions, hierarchical structures, shape property storage, and small or variable number representation. These techniques may be used independently or in combination in various embodiments, and may lead to small file sizes, fast view rendering, graphical capabilities similar to raster formats, zoom capabilities similar to vector formats, and attribute storage capabilities.

### CROSS-REFERENCE TO RELATED APPLICATIONS

This application claims the benefit of U.S. Provisional Application No. 60/249,840, filed Nov. 17, 2000.

### BACKGROUND OF THE INVENTION

This invention relates to systems and methods for representing and displaying graphics. More particularly, this invention relates to systems and methods for representing and displaying graphics on devices with limited storage capacity and processing power.

Generally speaking, there are two types of industry formats for representing graphical images: raster formats and vector formats. Raster formats store an image as a configuration of pixels, providing a highly graphical representation of an image. This format typically creates large data files (e.g., 1 megabyte (MB) for a simple image), requiring large storage space. With such large files, retrieval time from memory to a display screen is generally slow. In addition, raster formats have limited zoom capability. Common raster formats include bitmap (BMP), graphics interchange format (GIF), joint photograph experts group (JPEG), and tagged image file format (TIFF).

Vector formats store a description of an image using geometric objects such as points, lines, and polygons. A vector shape can be used to define a polygon by defining a path that outlines the shape. When an image stored in vector format is displayed, the vector image is ultimately displayed as a raster image in the form of pixels. Every point, line, and polygon can be represented as a grouping of pixels. Vector formats have smaller storage requirements and more flexible zoom requirements than raster formats, but lack the capacity to represent complex graphics. Common vector formats include shape file format, Digital Exchange Format (DXF), and Postscript.

Raster formats and vector formats are both flexible as to the image size and degree of resolution (i.e., the level of detail of an image, the relative proportion of an image). However, the larger the image and the greater its resolution, the larger the storage space requirements for a file representing the image. Large storage space requirements can make many images unsuitable for use by devices that have limited storage capacity and processing power (e.g., handheld devices such as Personal Digital Assistants (PDAs)).

In view of the foregoing, it would be desirable to provide systems and methods for representing and displaying graphical images that tend to minimize storage and processing requirements for displaying such images.

### SUMMARY OF THE INVENTION

It is therefore an object of this invention to provide systems and methods for representing and displaying graphical images that tend to minimize storage and processing requirements for displaying such images. Various embodiments and features of the present invention are described, for example, in U.S. Provisional Application No. 60/249,840, filed Nov. 17, 2000, which is hereby incorporated by reference herein in its entirety.

Various embodiments of the present invention may represent and display graphical images using one or more of several techniques. Some embodiments may use a first technique in which shapes are defined using vectors and small bitmap images which can be used to fill the shape. This may allow for a highly graphical representation of data with flexible zoom capabilities and small storage requirements.

Some embodiments may use a second technique, sometimes referred to herein as “primitive shape descriptions.” In such embodiments, primitive shapes such as points, lines (i.e., linear segments), circles, and ellipses may be described in a canonical form, thus reducing the size of data files.

Some embodiments may use a third technique, sometimes referred to herein as “shape property storage.” In such embodiments, certain shape properties, such as a shape's bounding box and centroid, may be calculated when a data file defining the shape is created and stored with the data file for fast rendering and shape property querying.

Some embodiments may use a fourth technique, sometimes referred to herein as a “hierarchical structure.” In such embodiments, shape information may be stored in a hierarchy with each shape having pointers to all shapes that lie within it. A hierarchical structure may result in fast view rendering.

Some embodiments may use a fifth technique, sometimes referred to herein as “small number representation.” An image may be divided into tiles, with a reference pair (or coordinate pair) associated with each tile. Within each tile, the points defining the shapes in each tile may be defined relative to the reference pair of the corresponding tile. In such embodiments, the points defining each tile may be represented in “short integer” (e.g., 2 byte) format. This may reduce the large storage requirements for large images. In other embodiments, an image may be described using variable number representation in the range from a sub-byte (i.e., less than one byte) to eight or more bytes, depending on the size of the image. Variable number representation allows for greater flexibility in representing shapes and more efficient storage of shapes.

Embodiments of the present invention may use one or more of these techniques to represent and display graphical images of any suitable type. For example, one or more of the techniques may be used to represent and display buttons and icons for a web page. In some embodiments, one or more of these techniques may be used to represent and display graphical images for maps in stand-alone applications. Because these approaches tend to minimize the storage and processing requirements for representing and displaying graphical images, they are highly suitable for computer-based platforms having limited storage and processing capabilities, such as hand-held computers and personal digital assistants, but may be used on any suitable computer-based platform (e.g., personal computers, set-top boxes, etc.).

In some embodiments, all of these techniques may be provided on a hand-held computer platform for generating maps. In such embodiments, the format for representing graphical images is sometimes referred to herein as “Digital Content Map” (DCM) format. DCM combines the advantages of both the conventional raster and vector formats. For example, DCM may allow data to be represented in small file sizes, may allow the information to be quickly rendered on a viewing platform, may provide a highly graphical representation of the data, may provide flexible zoom capabilities, and may provide attribute storage capabilities. DCM can be adapted to any device that has limited storage capacity and processing power, or even to any device capable of receiving data, regardless of storage capacity and processing power.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram illustrating one embodiment of a computer-based device in accordance with one embodiment of the present invention;

FIG. 2 is an illustration of a vector shape and bitmap brush used to create a hybrid shape in accordance with one embodiment of the present invention;

FIG. 3 is a flow diagram of an illustrative process for representing and displaying the shape of FIG. 2 in accordance with one embodiment of the present invention;

FIG. 4A is an illustration of a standard vector definition of an ellipse;

FIG. 4B is an illustration of a definition of an ellipse in accordance with one embodiment of the present invention;

FIG. 5A is an illustration of a standard vector definition of a circle;

FIG. 5B is an illustration of a definition of a circle-in accordance with one embodiment of the present invention;

FIG. 6A is an illustration of a standard vector definition of a linear segment;

FIG. 6B is an illustration of a definition of a linear segment in accordance with one embodiment of the present invention;

FIG. 7 is a flow diagram of an illustrative process for representing and displaying the primitive shape descriptions of FIGS. 4B, 5B, and 6B in accordance with one embodiment of the present invention;

FIG. 8 is a flow diagram of an illustrative process for utilizing shape property storage in accordance with one embodiment of the present invention;

FIG. 9A is an illustration of a hierarchical representation of shape objects in accordance with one embodiment of the present invention;

FIG. 9B is an illustration of an image when the hierarchical representation of the shape objects in FIG. 9A is displayed in accordance with one embodiment of the present invention;

FIG. 10 is a flow diagram of an illustrative process for representing and displaying the hierarchical shapes of FIGS. 9A and 9B in accordance with one embodiment of the present invention;

FIG. 11A is a flow diagram of an illustrative process for utilizing small number representation in accordance with one embodiment of the present invention;

FIG. 11B is a flow diagram of an illustrative process for utilizing variable number representation in accordance with one embodiment of the present invention;

FIG. 12 is an flow diagram of an illustrative process for displaying a graphical image in accordance with one embodiment of the present invention; and

FIG. 13 is a flow chart illustrating one embodiment of storing, retrieving, and displaying geo-spatial data in accordance with the present invention.

### DETAILED DESCRIPTION OF EMBODIMENTS OF THE INVENTION

The present invention provides systems and methods for representing and displaying graphical images that tend to minimize the storage and processing requirements for representing such images on devices with limited storage capacity and processing power.

Embodiments of the invention may represent and display various types of data on various computer-based devices such as personal computers, laptop computers, hand-held computers (e.g., personal digital assistant (PDA) style computers), set-top boxes, and cellular telephones. For purposes of illustration and not by way of limitation, various features of the present invention are sometimes described herein in the context of representing and displaying geo-spatial data on handheld computers.

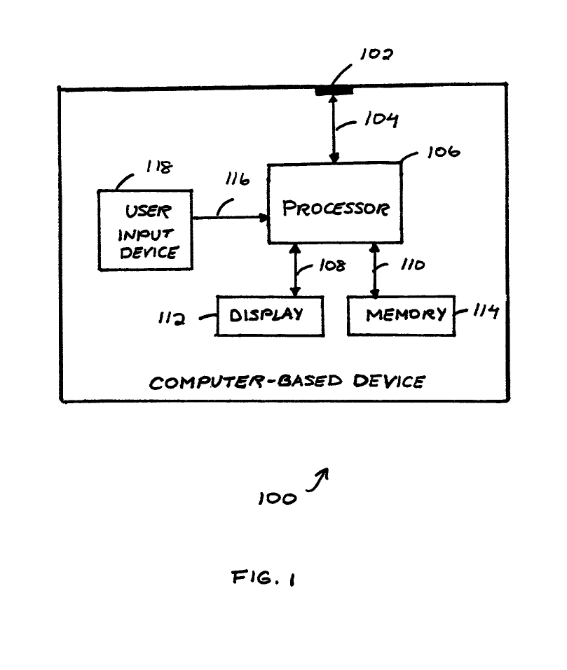

FIG. 1 illustrates a block diagram of a computer-based device 100 in accordance with one embodiment of the present invention. Computer-based device 100 may be any suitable device capable of retrieving and displaying graphical images. Graphical images may include web page data, geo-spatial (i.e., map) data, computer or video game data, digital pictures, etc. In some embodiments of the invention, device 100 may have a relatively large amount of storage capacity (e.g., 256 Megabytes (MB), 512 MB, 1 Gigabyte (GB), 4 GB) and processing power (e.g., 500 Megahertz (MHz), 1.0 Gigahertz (GHz)). In other embodiments, device 100 may have a relatively small amount of storage capacity (e.g., 8 MB, 16 MB) and processing power (e.g., 33 MHz, 233 MHz). Device 100 may obtain graphical images using any suitable approach. For example, device 100 may download images from a disk drive or from the world wide web. Device 100 may also attach a memory card to the device to obtain images or receive images from another computer (e.g., “beaming” data from one personal digital assistant (PDA) to another PDA), etc. Depending on the source, device 100 may obtain these graphical images via a communications port 102. In some embodiments, communications port 102 may be connected to a Global Positioning System (GPS) receiver via a communications link.

A processor 106 may have a variety of functions. Processor 106 may handle all input and output (I/O) between device 100 and any peripheral device. A user may control device 100 by sending commands to processor 106 using a user input device 118 connected to processor 106 via a data link 116. User input device 118 may be a pointing device, a wireless remote control, a keyboard, a touch-pad, a voice recognition system, or any other suitable user input device. A user may enter a command, for example, by clicking on a program icon with a pointing device, using a touch-pad to select a command, etc. In response to the user command, processor 106 may obtain graphical images from communications port 102 via a data link 104. Processor 106 may process the input data obtained from communications port 102 by storing the data in a memory 114 via a data link 110 in any suitable format. Memory 114 may be any suitable storage device, such as a random access memory (RAM), a read only memory (ROM), a flash memory, a hard disk drive, a combination of such devices, etc. Processor 106 may also process input data obtained from communications port 102 or from memory 114 by rendering the data on a display screen 112 via a data link 108 in any suitable format. Display screen may be any suitable display device such as a television screen, a computer monitor, a screen on a handheld device, a screen on a cellular telephone, etc. Data links 104, 108, 110, and 116 may be any suitable link, such as a data bus, that allows the transfer of data.

Various embodiments of the present invention may represent and display graphical images using one or more of the following techniques: defining shapes using vector shapes and small bitmap images, defining “primitive shape descriptions,” utilizing “shape property storage,” defining shapes in a “hierarchical structure,” and storing shape data using “small number representation” or “variable number representation.” These techniques may be used independently or in combination to represent and display images.

In some embodiments, the use of vector shapes and bitmap brushes may provide file sizes smaller than those created using raster formats, zoom capabilities similar to vector formats, and graphics capabilities similar to raster formats. General shapes can be represented as vector data by defining the shapes as a series of points which outline the shape. This may allow the shapes to be displayed at any zoom level without loss of precision. Unlike vector format, which lacks the ability to represent complex graphics, the present invention can represent complex graphics by defining a small bitmap image to be associated with any shape type. This bitmap may be treated as a “brush” by the display software, which may use the bitmap to “paint” the interior of the shape with a repeating pattern of the brush. Even though the shapes are defined as vectors, the advantages of bitmap storage are realized.

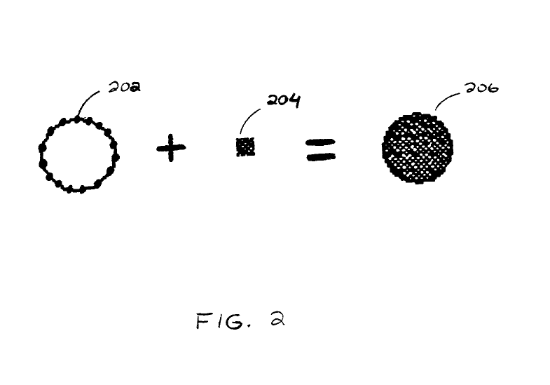

FIG. 2 illustrates one embodiment of using vector shapes and bitmap brushes to store an image. A circle, or any other shape, can be represented as a vector shape 202, which can be defined by a series of closely spaced points that form an outline of the shape. For a circle, the series of points form a circumference of the circle. A bitmap image 204 can be used to fill in the interior of vector shape 202 to produce a hybrid shape 206 that forms the resulting image.

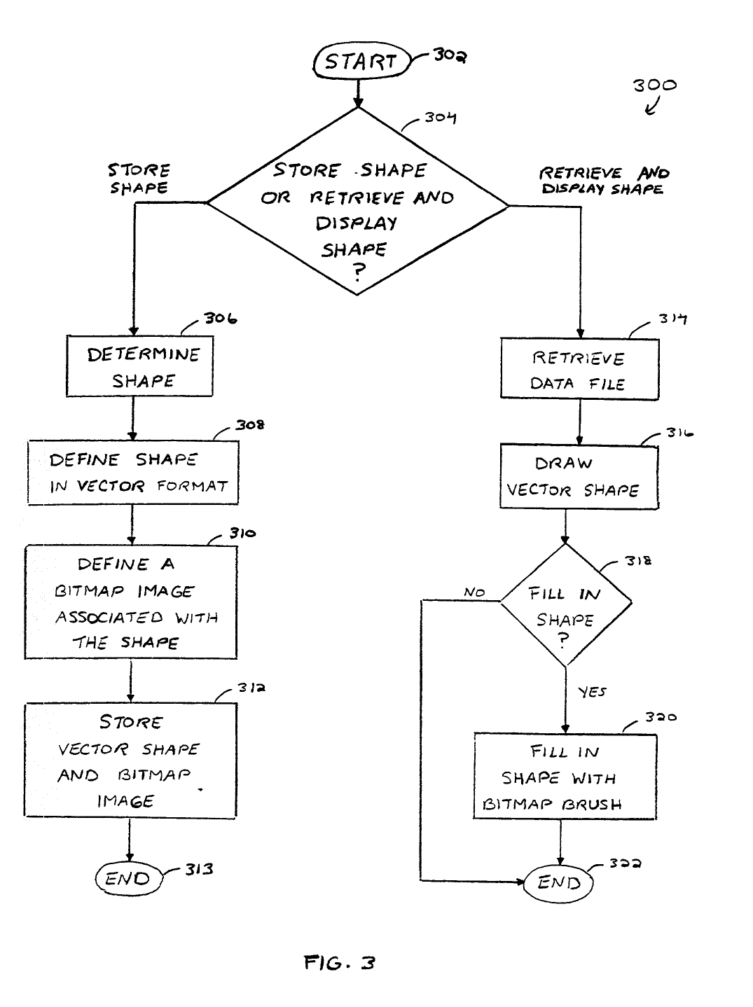

FIG. 3 is a flow diagram of an illustrative process 300 for representing and displaying a shape using vector shapes and bitmap brushes in accordance with one embodiment of the present invention. Process 300 begins at step 302. At step 304, process 300 determines whether to store a shape or to retrieve and display a shape from memory. If a shape is to be stored, process 300 proceeds to step 306 where a shape is determined (e.g., a circle, ellipse, linear segment, or polygon). At step 308, the shape may be defined in vector format by a series of points that form an outline of the shape. At step 310, a small bitmap image associated with the shape may be defined. Process 300 then proceeds to step 312, where the series of points (vector shape) and bitmap image that define the shape may be stored in a data file in memory and process 300 ends at step 313.

If a shape is to be retrieved and displayed, process 300 proceeds to step 314 where the data file containing the user commanded shape is retrieved from memory. At step 316, the vector shape may be drawn. At step 318, process 300 determines whether to fill in the interior of the vector shape. This may be determined by checking the data file for an associated bitmap image. If the interior of the shape is not to be filled in, process 300 ends at step 322. If the interior of the shape is to be filled in, process 300 proceeds to step 320 where the shape may be filled in with a repeated application of the associated bitmap image and the process ends at step 322.

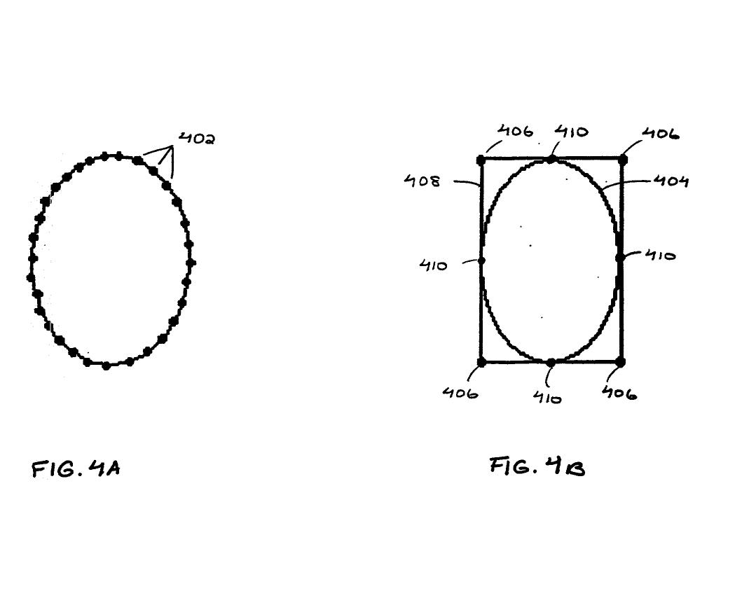

In some embodiments, primitive vector shape descriptions may be used to reduce the storage space of data files. Vector formats typically describe shapes as polygons by defining a series of coordinate points corresponding to each vertex of the polygon. This technique may be applied for arbitrary shapes but where possible, may represent simple vector shapes (e.g., ellipses, circles, and linear segments) in a more canonical form. Primitive shapes may be described using a limited number of coordinate points, scalar values, or both, significantly reducing storage space requirements. FIGS. 4A-B, 5A-B, and 6A-B illustrate examples of representing the following primitive shapes: an ellipse, a circle, and a linear segment, respectively, in canonical form.

FIGS. 4A-B illustrate two representations of an ellipse. FIG. 4A illustrates a standard vector definition of an ellipse defined by a series of points 402 that form an outline of the ellipse. FIG. 4B illustrates a definition of an ellipse 404 in accordance with one embodiment of the present invention. Ellipse 404 may be defined by four coordinate points 406, which may represent the vertices of a bounding box 408 that enclose ellipse 404. The bounding box 408 may be a rectangle such that the ellipse intersects each side of the bounding box 408 at one point (e.g., at midpoints 410). Alternatively, ellipse 404 may be defined by the four midpoints 410 of bounding box 408, which form the intersection points between bounding box 408 and ellipse 404.

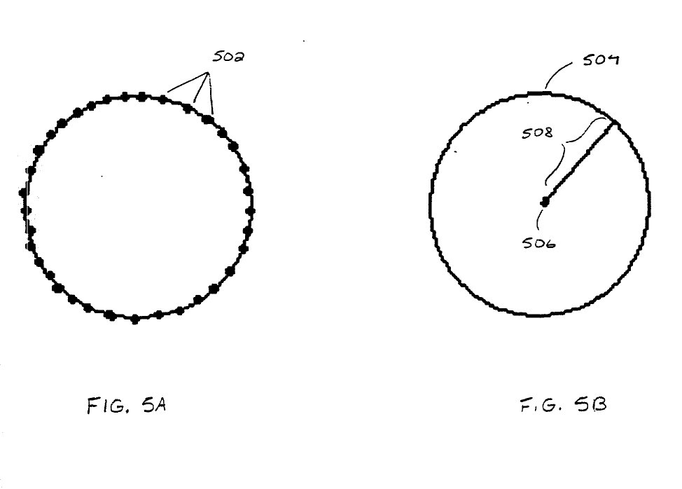

FIGS. 5A-B illustrate two representations of a circle. FIG. 5A illustrates a standard vector definition of a circle defined by a series of points 502 that form a circumference of the circle. FIG. 5B illustrates a definition of a circle 504 in accordance with one embodiment of the present invention. Circle 504 may be defined by a coordinate point 506 of a center of the circle and a scalar value 508 of a radius of the circle. The radius 508 is defined as a scalar distance from the center 506 of the circle to any point along the circumference 504 of the circle.

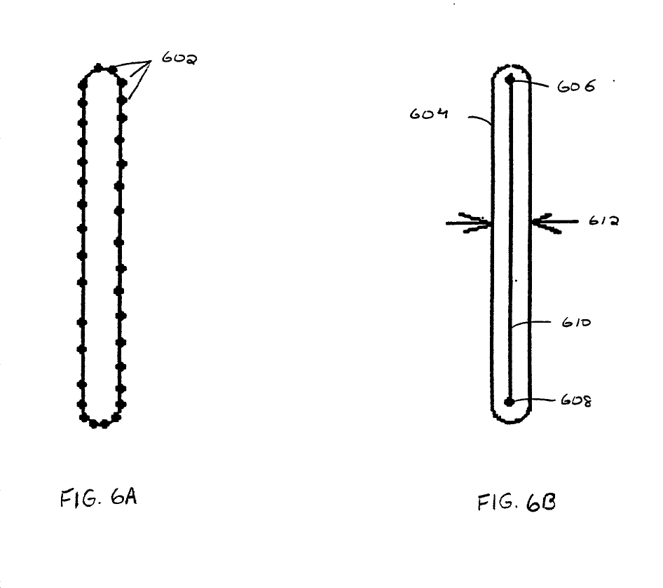

FIGS. 6A-B illustrate two representations of a linear segment. FIG. 6A illustrates a standard vector definition of a linear segment defined as a series of points 602 that outline the shape of the linear segment. FIG. 6B illustrates a definition of a linear segment 604 in accordance with one embodiment of the present invention. Linear segment 604 may be defined by two coordinate points 606 and 608 and a scalar value of a width 612 of the segment. The two coordinate points 606 and 608 may describe endpoints of, an “imaginary line” 610 down a center of the linear segment. A perpendicular (and shortest) distance from any point on the imaginary line 610 to an outline of linear segment 604 on either side is one-half the scalar width 612.

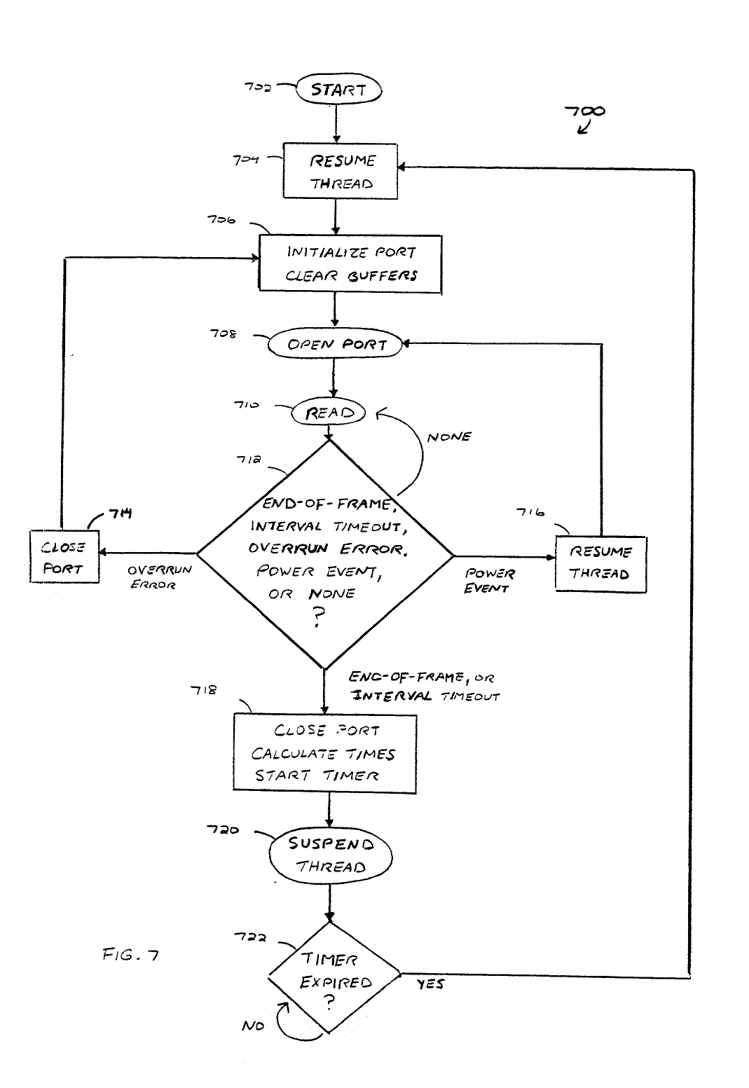

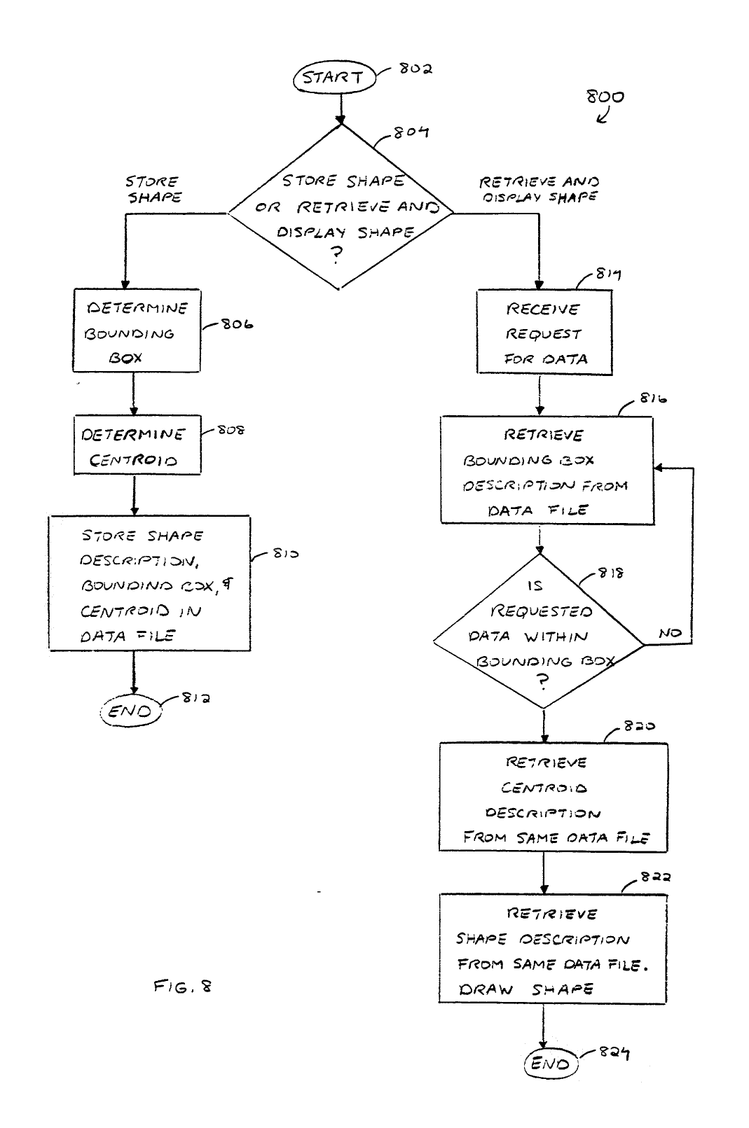

FIG. 7 is a flow diagram of an illustrative process 700 for representing and displaying the shapes of FIGS. 4B, 5B, and 6B using primitive shape descriptions in accordance with one embodiment of the present invention. Process 700 begins at step 702. At step 704, process 700 determines whether to store a shape or to retrieve and display a shape from memory. If a shape is to be stored, process 700 proceeds to step 706 where a shape is determined (e.g., a primitive shape such as a circle, ellipse, or linear segment, or a polygon (non-primitive shape)). At step 708, process 700 may determine whether the shape description matches that of an ellipse. If the shape is an ellipse, four coordinate points that form the ellipse's bounding box may be defined at step 710. The four coordinate points may define the vertices of the bounding box or the midpoints of the bounding box. If the shape is not an ellipse, process 700 proceeds to step 712 where the process may determine whether the shape description matches that of a circle. If the shape is a circle, a coordinate point representing the center of the circle and a scalar value representing the radius of the circle may be defined at step 714. If the shape is not a circle, process 700 proceeds to step 716 where the process may determine whether the shape description matches that of a linear segment. If the shape is a linear segment, two coordinate points representing endpoints of the linear segment and a scalar value representing the width of the linear segment may be defined at step 718. If the shape is not a linear segment, process 700 proceeds to step 720 where any other suitable shape (i.e., a polygon) may be defined. After the shape is defined at step 710, step 714, step 718, or step 720, process 700 proceeds to step 722 where the shape definitions may be stored in a data file in memory and the process ends at step 724.

If a shape is to be retrieved and displayed, process 700 proceeds to step 726 where a shape description (in the form of coordinate points, scalar values, or both) stored in a data file may be retrieved from memory. At step 728, process 700 may determine whether the shape description matches that of an ellipse. If the shape is an ellipse, the appropriately sized ellipse is drawn at step 730. If the shape is not an ellipse, process 700 proceeds to step 732 where the process may determine whether the shape description matches that of a circle. If the shape is a circle, the appropriately sized circle is drawn at step 734. If the shape is not a circle, process 700 proceeds to step 736 where the process may determine whether the shape description matches that of a linear segment. If the shape is a linear segment, the appropriately sized linear segment is drawn at step 738. If the shape is not a linear segment, process 700 proceeds to step 740 where the appropriate vector shape (i.e., polygon) may be drawn. The process may determine the shape descriptions in any order (e.g., circle first, linear segment second, and ellipse third), together in a single step, or any other suitable method. The process may first determine whether the shape is a primitive shape. If the shape is not a primitive shape, the polygon may be stored or displayed in vector format. After the shape is drawn at step 730, step 734, step 738, or step 740, process 700 ends at step 742.

In some embodiments, certain shape properties may be useful for fast rendering and shape property querying. Two examples are a shape's bounding box (i.e., a rectangle that entirely encloses the shape) and a centroid (i.e., a shape's geometric center). These two properties may be calculated when a data file defining the shape is created and stored with the shape. This can lead to fast view rendering because the bounding box and centroid do not have to be calculated during the retrieval of data. A shape's bounding box can be used to quickly determine whether a particular point or object is contained within a shape. If a point or object is not contained within the bounding box, it does not lie within the shape.

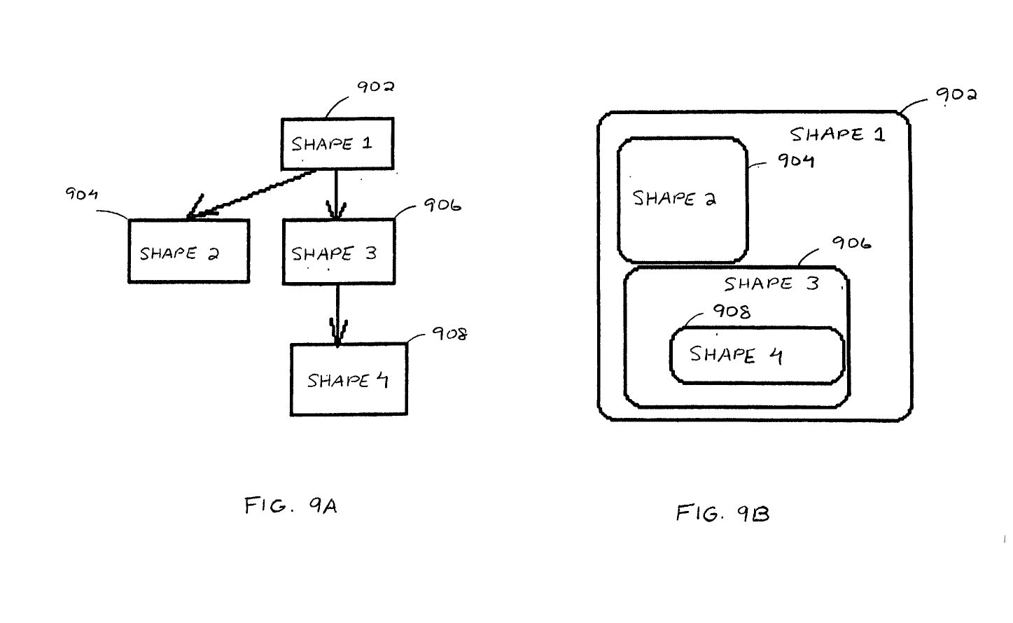

FIG. 8 is flow diagram of an illustrative process 800 for utilizing shape property storage in accordance with one embodiment of the present invention. Process 800 begins at step 802. At step 804, process 800 determines whether to store a shape or to retrieve and display a shape from memory. If a shape is to be stored, process 800 proceeds to step 806 where the shape's bounding box may be determined. The shape's bounding box may be defined by a series of points that outline a rectangle that encloses the shape. Alternatively, the bounding box may be defined by coordinate points that define vertices of the bounding box or that define midpoints of the bounding box. At step 808, the shape's centroid may be defined by a coordinate point. At step 810, process 800 stores the shape's bounding box (e.g., defined as a series of points outlining the bounding box, vertices, midpoints) and centroid (e.g., defined by a coordinate point) in a data file in memory. The bounding box and centroid may be stored in the same data file as the shape description or separately. Process 800 then ends at step 812.

If a shape is to be retrieved and displayed, process 800 proceeds to step 814 where process 800 may receive a request for data from the user. For example, a user may enter a website address and data (e.g., in the form of buttons and icons) corresponding to that website may be retrieved and displayed. At step 816, process 800 may retrieve a bounding box description in a data file from memory. At step 818, process 800 determines whether the requested data lies within the bounding box. If the data does not lie within the bounding box, process 800 returns to step 816 to retrieve a bounding box description from a different data file in memory. If the data lies within the bounding box, process 800 proceeds to step 820 to retrieve a centroid description in the same data file. At step 822, process 800 retrieves the shape description from the data file containing the appropriate bounding box and centroid, and draws the shape in the appropriate position (centered about the centroid and within the bounding box). Process 800 then ends at step 824.

In some embodiments, shape information may be stored in a hierarchical format to render a view of the map quickly and efficiently. Each shape (called a “parent”) can have pointers to all shapes (called “children”) that are entirely contained within it. Rendering software can begin with any shape in the hierarchy and can issue a draw command. Each shape in turn can issue draw commands to the shapes that are listed as children of that particular shape. Each level in the hierarchy can represent a level in the drawing. Highest order shapes are drawn first. Next, the children are drawn within the higher order shapes. This way, complex queries, such as which shape contains a particular feature, can also be implemented in a hierarchical fashion. For example, if rendering software needs to determine the shape that is lowest in the hierarchy that contains a particular point, the software may call a function associated with the top level shape. This in turn may call the appropriate function associated with each of its children until the hierarchy has been descended to its lowest level. Alternatively, the lowest order shape may be drawn first and then each higher order shape may be drawn in succession until the highest order shape is drawn.

In some embodiments, the hierarchical format may provide for fast view rendering. For example, if a particular point (e.g., location) is requested, the high-order shape that the point lies in may be determined. Once the high-order shape that contains the point is determined, the lower order shapes may be called up to determine which lower order shape the point lies in. Testing the point in several higher order shapes may be more efficient than testing many lower order shapes. For some embodiments, the hierarchical format may provide a more efficient and accurate way of displaying an image. An image can be drawn in sections in a systematic order rather than randomly. In addition, this technique renders shapes in the correct order so that certain shapes are not overlaid by other shapes undesirably.

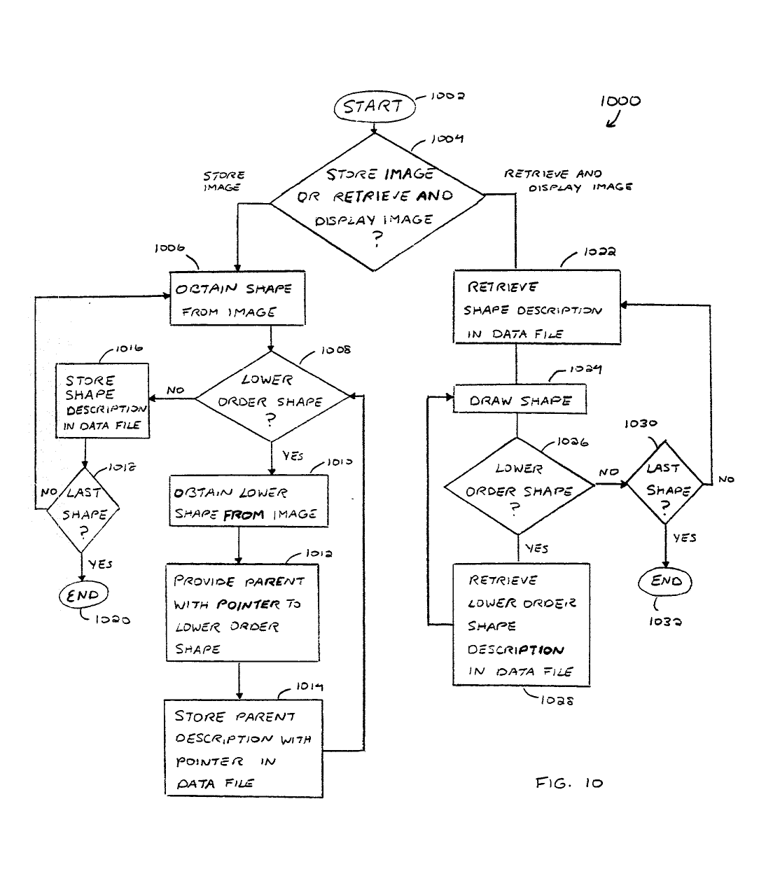

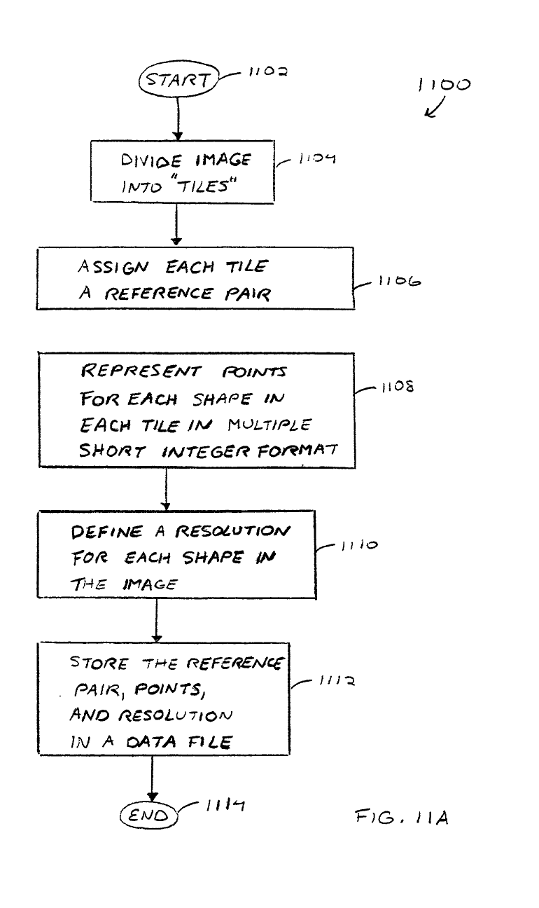

FIGS. 9A-B illustrate one embodiment of a hierarchical structure. FIG. 9A is a flow chart of the hierarchical representation of four shape objects. “Shape 1” 902 is the highest order shape, or parent. “Shape 2” 904 and “Shape 3” 906 are children of “Shape 1” 902. “Shape 4” 908 is the child of parent “Shape 3” 906. FIG. 9B illustrates the resulting image when the shapes in FIG. 9A are drawn. “Shape 1” 902 is drawn first. Next, “Shape 2” 904 and “Shape 3” 906 are drawn entirely within parent “Shape 1” 902. Finally, “Shape 4” 908 is drawn entirely within parent “Shape 3” 906.

FIG. 10 is a flow diagram of an illustrative process 1000 for representing and displaying images using the shape hierarchy of FIGS. 9A and 9B in accordance with one embodiment of the present invention. Process 1000 begins at step 1002. At step 1004, process 1000 determines whether to store an image or to retrieve and display an image from memory. If an image is to be stored, process 1000 proceeds to step 1006 where a parent shape may be obtained from the image (the parent shape is the largest shape from which all other shapes are entirely contained within). At step 1008, process 1000 may determine whether there is a lower order shape. If there is a lower order shape, process 1000 proceeds to step 1010 where the lower order shape may be obtained from the image. At step 1012, a pointer to the lower order shape may be provided to the parent shape. Then at step 1014, a description of the parent shape, along with the pointer to the lower order shape, may be stored in a data file in memory. Process 1000 then returns to step 1008 where the process determines whether the lower order shape (which becomes a parent) has a lower order shape. If there is no lower order shape, process 1000 proceeds to step 1016 where a description of the shape may be stored in a data file in memory. At step 1018, process 1000 determines whether the last shape has been obtained from the image. If there is another shape in the image, process 1000 returns to step 1006 to obtain another shape. If there are no more shapes in the image, the process ends at step 1020.

If an image is to be retrieved and displayed, process 1000 proceeds to step 1022 where a description of a parent shape is retrieved in a data file in memory. At step 1024, the parent shape is drawn. At step 1026, process 1000 determines whether a lower order shape exists (e.g., by checking the data file for a pointer that is associated with the newly drawn shape). If a lower order shape exists, process 1000 proceeds to step 1028 where a description of the lower order shape may be retrieved in the data file in memory. Process 1000 then returns to step 1024 where the lower shape is drawn and the process begins for determining whether a lower order shape exists. If a lower order shape does not exist, process 1000 proceeds to step 1030 where the process determines whether the last shape has been drawn. If the last shape has not been drawn, process 1000 returns to step 1022 to retrieve a next shape. If the last shape has been drawn, process 1000 ends at step 1032.

In some embodiments, large number formats, such as double precision floating-point numbers or long integer types, are used to describe coordinate points defining each shape in an image. This approach may require more storage capacity than desired. In other embodiments, a technique sometimes referred to herein as “small number representation” is used. In this technique, an image may be divided into several tiles where each tile represents a portion of the image in the form of a rectangle or other orthogonal shape. Each tile may be assigned a reference pair, which may be a coordinate point (e.g., latitude and longitude, an x and y coordinate) that describes a location or position of, for example, a lower left-hand corner of the tile. Each tile in an image may be assigned a reference pair that describes the same part of the tile (e.g., a lower left-hand or right-hand corner, an upper left-hand or right-hand corner, or a center of each tile). The reference pair for each tile may be stored as two double precision floating-point numbers.

Each shape in a tile may be described by points that are referenced relative to the reference pair for the tile. For example, if a reference pair is assigned to a lower left-hand corner of a tile, a point in the tile may be referenced by a certain number of units to the right of and a certain number of units up from the reference pair. Because each point in a tile is referenced relative to the reference pair for the tile rather than as an individual coordinate point, each point may be represented in multiple short integer formats. Multiple tiles may be placed together (called “tiling” sections) to make up a larger image. This technique can reduce the storage requirements by up to a factor of four.

In other embodiments, a technique sometimes referred to herein as “variable number representation” may be used. Points used to define each shape in an image may be defined in a range from a sub-byte (i.e., less than one byte) up to eight or more bytes, depending on the size and location of an image. This approach may provide a more efficient way of storing data because each shape may be stored using as much or as little storage space as needed, rather than using a set storage size for each point. For some embodiments, tiling may be used for large images. However, the size of the tiles may be larger than the sizes used in the small number representation technique. For other embodiments, tiling may not be used. For both the small and variable number representations, an additional byte (or any other suitable size) describing a resolution of each shape may be stored in the same data file as the shape.

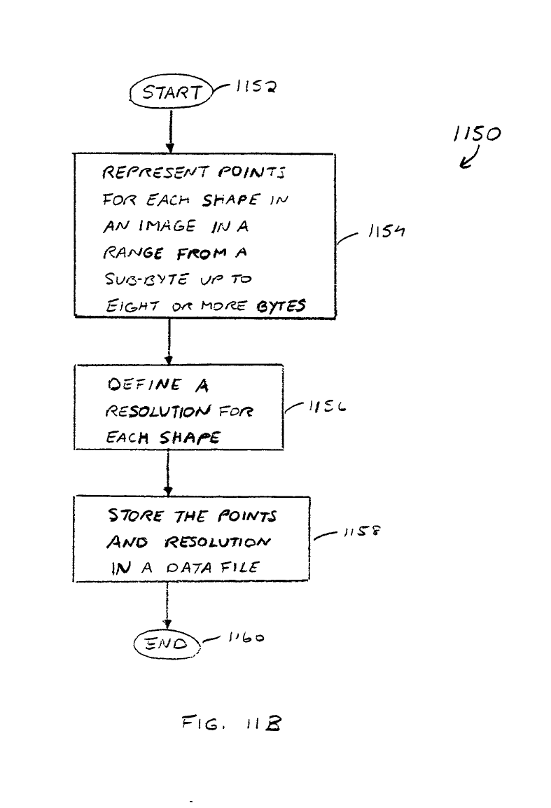

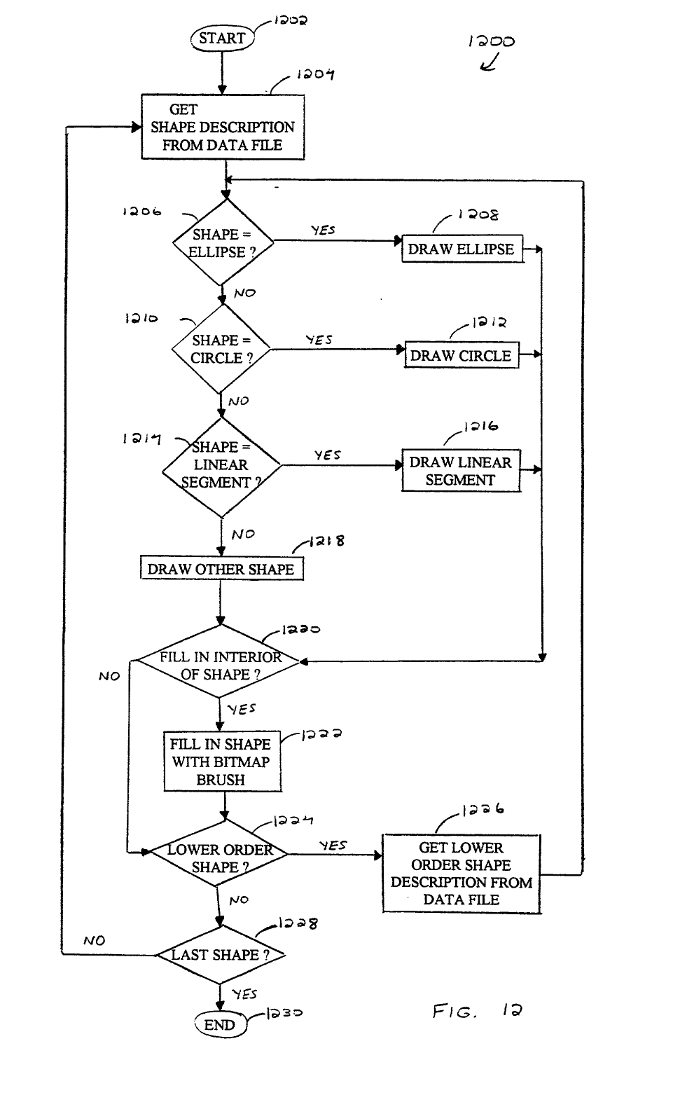

FIG. 11A is a flow diagram of an illustrative process 1100 for representing an image in small number representation in accordance with one embodiment of the present invention. Process 1100 begins at step 1102 with an image. At step 1104, the image may be divided into several “tiles,” where each tile represents a piece of the image. The larger the image, the more tiles the image may be divided into. At step 1106, each tile may be assigned a reference pair that allows multiple tiles to be correctly “tiled” together to form a larger image. At step 1108, points describing shapes in each tile may be represented using small number representation (e.g., in multiple short integer format points (2 byte)). At step 1110, a byte (or any other suitable size) may be associated with each shape that describes the shape's resolution. At step 1112, process 1100 may store the reference pair associated with each tile, the points describing the shapes in each tile, and the resolution byte corresponding to each shape in one or multiple data files in memory and the process ends at step 1114.

FIG. 11B is a flow diagram of an illustrative process 1150 for representing an image in variable number representation in accordance with one embodiment of the present invention. Process 1150 begins at step 1152 with an image. At step 1154, points describing shapes in each tile may be represented using variable number representation (e.g., in a range from a sub-byte to eight or more bytes). At step 1156, a byte (or any other suitable size) may be associated with each shape that describes the shape's resolution. At step 1158, process 1150 stores the points describing the shapes in each tile and the resolution byte corresponding to each shape in one or multiple data files in memory and the process ends at step 1160. If the image is to be tiled, the process of storing the image may follow process 1100 of FIG. 11A with the difference that at step 1104, the image may be divided into larger tile sizes, and at step 1108, the points defining each shape may be represented using variable number representation.

Implementation of the above techniques may be achieved through computer programming languages that support Object Oriented Programming (OOP) (e.g., C++, Java, etc.), or any other suitable computer language. In an object-oriented approach, a basic object may be to construct a image format defined in a class (e.g., “CShapeObj”). The objects of this class may be abstract, meaning that other similar objects may be derived from the given base class (e.g., “CShapeObj”). Each technique may be made up of a number of objects created with the given class, also called methods.

The use of vector shapes and bitmap brushes, primitive shape descriptions, shape property storage, hierarchical representation, and small (or variable) number representation as described above can be combined to provide a highly compressed image representation that combines the advantages of both raster and vector formats. Sometimes referred to herein as “Digital Content Map” (DCM), DCM provides a more efficient way to store files in computer devices, particularly in computer devices with limited storage capacity and processing power. Advantages of using DCM include being able to represent image data in small file sizes, fast view rendering capabilities, graphics capabilities similar to raster formats, zoom capabilities similar to vector formats, and attribute storage capabilities.

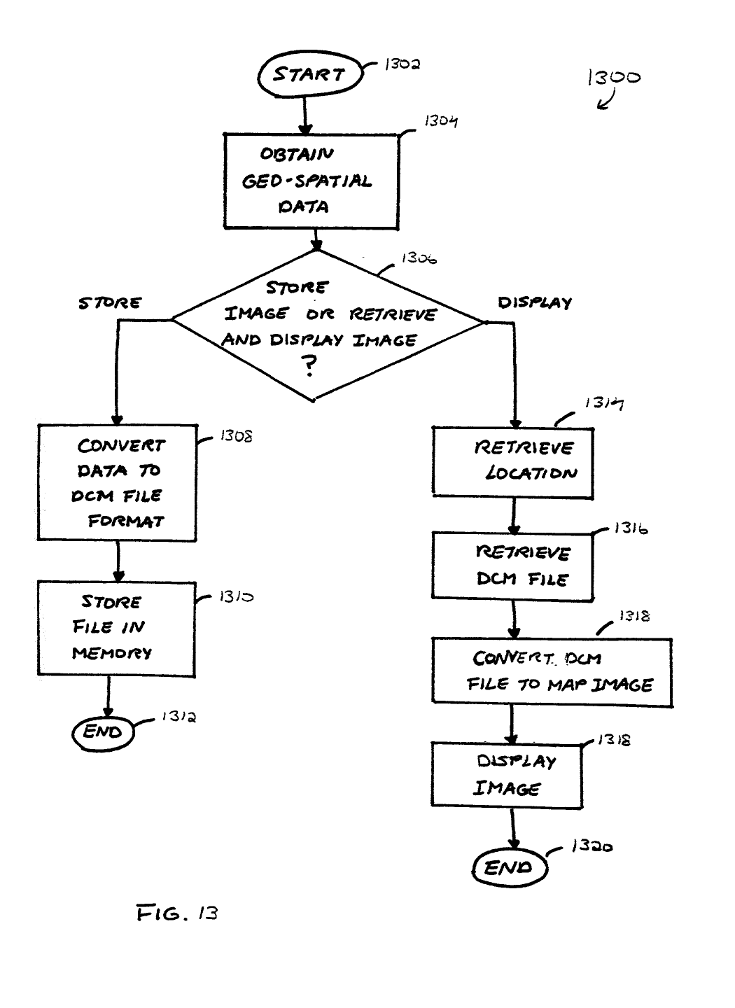

FIG. 12 is a flow diagram of an illustrative process 1200 for displaying an image stored in a DCM format file in accordance with one embodiment of the present invention. Process 1200 begins at step 1202 with a request from a user for a reference to an image. A data file may be retrieved from memory and process 1200 may determine whether the reference (e.g., a point) is contained within the shape in the data file. This may be determined by retrieving the shape's bounding box from the data file.

If the point lies within the bounding box, the corresponding shape description may be retrieved at step 1204. The shape description may be in the form of coordinate points, scalar values, or both. For a primitive shape (e.g., an ellipse, circle, linear segment), the shape description may be in a limited number of coordinate points and scalar values. For a non-primitive shape (i.e., a polygon), the shape description may include a series of points outlining the shape. At step 1206, process 1200 may determine whether the shape description matches that of an ellipse. If the shape is an ellipse, the appropriately sized ellipse may be drawn at step 1208. If the shape is not an ellipse, process 1200 proceeds to step 1210 where the process may determine whether the shape description matches that of a circle. If the shape is a circle, the appropriately sized circle may be drawn at step 1212. If the shape is not a circle, process 1200 proceeds to step 1214 where the process may determine whether the shape description matches that of a linear segment. If the shape is a linear segment, the appropriately sized linear segment may be drawn at step 1216. If the shape is not a linear segment, process 1200 proceeds to step 1218 where the appropriate vector shape (i.e., polygon) may be drawn. The process may determine the shape descriptions in any order (e.g., circle first, linear segment second, and ellipse third), together in a single step, or any other suitable method. Furthermore, other shapes may be included.

After a vector shape is drawn at step 1208, step 1212, step 1216, or step 1218, process 1200 proceeds to step 1220 where the process may determine whether the interior of the shape (ellipse, circle, linear segment, or polygon) needs to be filled in. If the interior needs to be filled in, process 1200 proceeds to step 1222 where the shape may be filled in using a bitmap brush corresponding to the shape. After step 1222, or if the interior of the shape is determined to not need to be filled in at step 1220, process 1200 may determine if there is a lower order shape (child) at step 1224. This may be performed by checking if the shape description has a pointer to a lower order shape. If a lower order shape exists, the corresponding shape description may be retrieved at step 1226 and process 1200 returns to step 1206. If there is no lower order shape, process 1200 may determine whether the shape drawn is the last shape in the image at step 1228. If it is not the last shape, process 1200 returns to step 1204. If the last shape has been drawn, process 1200 may end at step 1230. In other embodiments, steps 1224 and 1228 may be combined into a single step and if more shapes need to be drawn, process 1200 returns to step 1204. Process 1200 may also apply to tiling where several iterations of process 1200 may be used to tile sections of an image.

One embodiment of the present invention applies to geo-spatial data, which provides mapping information for a number of geographical areas. This geo-spatial data is typically stored as a data file in memory. Position information may be used to retrieve the geo-spatial data for a particular geographic area. For example, a peripheral device, such as Global Positioning System (GPS) receiver, may obtain location information (i.e., latitude and longitude information) from GPS satellites orbiting the Earth. This location information may then be used to retrieve and display the data file that contains the geo-spatial data for that position.

Two main features of geo-spatial data which are stored in the data file are location and attributes. Location identifies a particular locality and may be determined by providing longitude and latitude coordinates, providing a name of a place, zooming to a particular area on a map, etc. Attribute data describes characteristics and properties of the particular locality. Geo-spatial data is conventionally stored and processed in one of two main industry standard map formats: raster formats and vector formats. In one embodiment of the present invention, geo-spatial data may be stored and processed in the DCM format illustrated above.

FIG. 13 is a flow chart illustrating one embodiment of storing, retrieving, and displaying geo-spatial data in accordance with the present invention. Process 1300 begins at step 1302. Next, process 1300 obtains geo-spatial data at step 1304 using, for example, a GPS receiver. At step 1306, process 1300 determines whether to store an image or to retrieve and display an image.

If a user selects to store an image into memory, process 1300 proceeds to step 1308 where the geo-spatial data may be converted to a Digital Content Map (DCM) file format. There may be one file for the image or there may be several files that can be tiled together to form the image. DCM file format may create a file of the data image in a highly compressed map representation using the techniques described above, reducing the size of the file while still retaining many of the properties of the data image. At step 1310, the new file may be stored into memory and then the storing process ends at step 1312.

If the user selects to retrieve and display an image at step 1306, process 1300 proceeds to step 1314 where location information of a desired locality is retrieved. The location can be determined a number of ways described above. The selected location information can be used to retrieve the corresponding geo-spatial data by matching the location information to a geo-reference description. The geo-reference description may be incorporated into the DCM file and can contain coordinates of the geo-spatial data contained in the corresponding DCM file. Any suitable coordinate system can be used, including a latitude and longitude coordinate system (e.g., an x- and y-axis) and an orthogonal coordinate system (e.g., Universal Transverse Mercator, State Plane, etc.). At step 1316, the DCM file containing the selected geo-reference description is retrieved from memory. At step 1318, the file is converted from DCM file to the map image in a form suitable for display on the computer device. At step 1318, the image is displayed and process 1300 ends at step 1320.

Thus it is seen that the present invention provides techniques for representing and displaying graphics on devices that tend to minimize the storage and processing requirements for representing such images on devices with limited storage capacity and processing power. One skilled in the art will appreciate that the present invention can be practiced by other than the described embodiments, which are presented for purposes of illustration and not of limitation, and the present invention is limited only by the claims which follow.

What is claimed is:

1. A method for representing and displaying an image on a computer-based device, the method comprising:
defining a vector shape that represents the image;
defining a bitmap to be associated with the vector shape;
displaying the vector shape; and
repeatedly displaying the bitmap with the vector shape to fill in the interior of the displayed vector shape.

2. A method for representing and displaying an image on a computer-based device, the method comprising:
determining a primitive shape that represents the image;
defining the primitive shape using coordinate points and scalar values; and
displaying the primitive shape based on the coordinate points and scalar values.

3. The method of claim 2 wherein determining the primitive shape comprises determining that the primitive shape is one of an ellipse, a circle, and a linear segment.

4. The method of claim 2 wherein defining the primitive shape using coordinate points and scalar values comprises:
defining an ellipse by four coordinate points;
defining a circle by a coordinate point and a scalar value; and
defining a linear segment by two coordinate points and a scalar value.

5. The method of claim 2 wherein displaying the primitive shape comprises:
displaying an ellipse based on four coordinate points that define four vertices of a bounding box that surround the ellipse, where a midpoint on each side of the bounding box intersects with a point on the ellipse.

6. The method of claim 2 wherein displaying the primitive shape comprises:
displaying an ellipse based on four coordinate points that define four midpoints of a bounding box that surround the ellipse, where a midpoint on each side of the bounding box intersects with a point on the ellipse.

7. The method of claim 2 wherein displaying the primitive shape comprises:
displaying a circle based on a coordinate point that defines a center of the circle and a scalar value that defines a radius of the circle, wherein the radius of the circle measures a distance from the center of the circle to any point along a circumference of the circle.

8. The method of claim 2 wherein displaying the primitive shape comprises:
displaying a linear segment based on two coordinate points that define endpoints of an imaginary line that forms down a center of the linear segment and a scalar value that defines a width of the linear segment, wherein a perpendicular distance from any point on the imaginary line to an outline of the linear segment on either side of the imaginary line is one-half the width of the linear segment.

9. A method for representing and storing an image on a computer-based device, the method comprising:
calculating a bounding box for a shape representing the image, wherein the bounding box encloses the shape and each side of the bounding box intersects a point of the shape;
calculating a centroid for the shape, wherein the centroid is the shape's geometric center; and
storing the bounding box and the centroid with the shape in memory.

10. The method of claim 9 further comprising:
determining whether a point is contained within the bounding box; and
displaying the shape centered about the centroid if the point is contained within the bounding box.

11. A method for representing and displaying an image on a computer-based device, the method comprising:
retrieving a first vector shape and a reference to a second vector shape from memory;
displaying the first vector shape;
retrieving the referenced second vector shape from memory; and
displaying the second vector shape within the first vector shape.

12. The method of claim 11 wherein retrieving the first vector shape comprises retrieving a shape in the image from which all other shapes are entirely contained within the first vector shape.

13. A method for representing and displaying an image on a computer-based device, the method comprising:
dividing the image into multiple tiles;
assigning a reference pair to a tile;
representing points that define shapes in the tile in multiple format points; and
displaying and positioning the tile next to another tile based on the reference pair assigned to both tiles.

14. The method of claim 13 wherein dividing the image into multiple tiles comprises dividing the image into orthogonal blocks.

15. The method of claim 13 wherein assigning the reference pair to the tile comprises defining a coordinate point on the tile, wherein the coordinate point describes a location of the tile in the image and is stored as two double-precision floating-point numbers.

16. The method of claim 13 wherein assigning the reference pair to the tile comprises defining a position of the tile in relation to other tiles in the image.

17. The method of claim 13 wherein representing the points that define the shapes in the tile in multiple format points comprises defining the points relative to the reference pair in multiple short integer format points.

18. The method of claim 13 wherein representing the points that define the shapes in the tile in multiple format points comprises defining the points in one of a range of sizes from less than a byte to about eight bytes.

19. A method for representing and displaying geo-spatial data on a handheld device, the method comprising:
storing the geo-spatial data in a data file in memory;
receiving location information which references the geo-spatial data in the data file;
determining whether the location information is contained within a bounding box that encloses a shape stored in the data file;
retrieving from the data file a first shape description if the location information is contained within the bounding box;
displaying a first vector shape associated with the first shape description;
repeatedly displaying the bitmap with the first vector shape to fill in the interior of the displayed first vector shape if the interior of the first vector shape is to be filled in;
retrieving from the data file a second shape description if the first vector shape has a pointer to a second vector shape; and
displaying the second vector shape associated with the second shape description within the first vector shape.

20. The method of claim 19 wherein storing the geo-spatial data in the data file in memory comprises:
dividing the geo-spatial data into multiple tiles;
assigning a reference pair to a tile;
representing points that define shapes in the tile in multiple format points; and
displaying and positioning the tile next to another tile based on the reference pair assigned to both tiles.

21. The method of claim 20 wherein assigning the reference pair to the tile comprises defining a coordinate point on the tile, wherein the coordinate point describes a location of the tile in the geo-spatial data and is stored as two double-precision floating-point numbers.

22. The method of claim 20 wherein representing points that define the shapes in the tile in multiple format points comprises defining points describing shapes relative to the reference pair in multiple short integer format points.

23. The method of claim 20 wherein representing points that define the shapes in the tile in multiple format points comprises defining the points in one of a range of sizes from less than a byte to about eight bytes.

24. The method of claim 19 wherein retrieving from the data file the first shape description comprises determining whether the first shape description is one of an ellipse, a circle, a linear segment, and a polygon.

25. The method of claim 19 wherein displaying the first vector shape comprises:
displaying an ellipse based on four coordinate points that define four vertices of a bounding box that surround the ellipse and whose midpoints on each side of the bounding box coincide with one point on the ellipse.

26. The method of claim 19 wherein displaying the first vector shape comprises:
displaying an ellipse based on four coordinate points that define four midpoints of a bounding box that surround the ellipse, wherein each midpoint coincides with one point on the ellipse.

27. the method of claim 19 wherein displaying the first vector shape comprises:
displaying a circle based on a coordinate point that defines a center of the circle and a scalar value that defines a radius of the circle, wherein the radius of the circle measures a distance from the center of the circle to any point along a circumference of the circle.

28. The method of claim 19 wherein displaying the first vector shape comprises:
displaying a linear segment based on two coordinate points that define endpoints of an imaginary line that forms down a center of the linear segment and a scalar value that defines a width of the linear segment, wherein a perpendicular distance from any point on the imaginary line to an outline of the linear segment on either side of the imaginary line is one-half the width of the linear segment.

29. The method of claim 19 wherein displaying the first vector shape comprises:
displaying a polygon based on a series of coordinate points that define each vertex of the polygon.

30. The method of claim 19 further comprising:
determining if the second vector shape is a lowest order shape in the geo-spatial data; and
retrieving from the data file a third shape description if the second vector shape has a pointer to a third vector shape.

31. The method of claim 19 further comprising determining if the second vector shape is a last shape in the geo-spatial data.

32. A system for representing and displaying an image on a computer-based device, the system comprising:
a display device;
a memory; and
a processor programmed to:
define a vector shape that represents the image stored in the memory,
define a bitmap to be associated with the vector shape stored in the memory,
display the vector shape on the display device, and
repeatedly display the bitmap with the vector shape to fill in the interior of the displayed vector shape on the display device.

33. A system for representing and displaying an image on a computer-based device, the system comprising:
a display device;
a memory; and
a processor programmed to:
determine a primitive shape that represents the image,
define the primitive shape using coordinate points and scalar values stored in the memory, and
display the primitive shape based on the coordinate points and scalar values on the display device.

34. The system of claim 33 wherein the processor, in determining the primitive shape, further determines that the primitive shape is one of an ellipse, a circle, and a linear segment.

35. The system of claim 33 wherein the processor, in defining the primitive shape, is programmed to:
define an ellipse by four coordinate points,
define a circle by a coordinate point and a scalar value, and
define a linear segment by two coordinate points and a-scalar value.

36. The system of claim 33 wherein the processor, in displaying the primitive shape, further displays an ellipse based on four coordinate points that define four vertices of a bounding box that surround the ellipse, where a midpoint on each side of the bounding box intersects with a point on the ellipse.

37. The system of claim 33 wherein the processor, in displaying the primitive shape, further displays an ellipse based on four coordinate points that define four midpoints of a bounding box that surround the ellipse, where a midpoint on each side of the bounding box intersects with a point on the ellipse.

38. The system of claim 33 wherein the processor, in displaying the primitive shape, further displays a circle based on a coordinate point that defines a center of the circle and a scalar value that defines a radius of the circle, wherein the radius of the circle measures a distance from the center of the circle to any point along a circumference of the circle.

39. The system of claim 33 wherein the processor, in displaying the primitive shape, further displays a linear segment based on two coordinate points that define endpoints of an imaginary line that forms down a center of the linear segment and a scalar value that defines a width of the linear segment, wherein a perpendicular distance from any point on the imaginary line to an outline of the linear segment on either side of the imaginary line is one-half the width of the linear segment.

40. A system for representing and storing an image on a computer-based device, the system comprising:
a memory; and
a processor programmed to:
calculate a bounding box for a shape representing the image, wherein the bounding box encloses the shape and each side of the bounding box intersects a point of the shape,
calculate a centroid for the shape, wherein the centroid is the shape's geometric center, and
store the bounding box and the centroid with the shape in the memory.

41. The method of claim 40 wherein the processor further determines whether a point is contained within the bounding box and displays the shape centered about the centroid on a display device if the point is contained within the bounding box.

42. A system for representing and displaying an image on a computer-based device, the system comprising:
a display device;
a memory; and
a processor programmed to:
retrieve a first vector shape and a reference to a second vector shape from the memory,
display the first vector shape on the display device,
retrieve the referenced second vector shape from the memory, and
display the second vector shape within the first vector shape on the display devices.

43. The system of claim 42 wherein the processor, in retrieving the first vector shape, further retrieves a shape in the image from which all other shapes are entirely contained within the first vector shape.

44. A system for representing and displaying an image on a computer-based device, the system comprising:
a display device;
a memory; and
a processor programmed to:
divide the image into multiple tiles and stores the multiple tiles in memory,
assign a reference pair to a tile and stores the reference pair in memory,
represent points that define shapes in the tile in multiple format points and stores the multiple format points in memory, and
display and position the tile next to another tile based on the reference pair assigned to both tiles on the display device.

45. The system of claim 44 wherein the processor, in dividing the image into multiple tiles, further divides the image into orthogonal blocks.

46. The system of claim 44 wherein the processor, in assigning the reference pair to the tile, further defines a coordinate point on the tile, wherein the coordinate point describes a location of the tile in the image and is stored as two double-precision floating-point numbers.

47. The system of claim 44 wherein assigning the reference pair to the tile comprises defining a position of the tile in relation to other tiles in the image.

48. The system of claim 44 wherein the processor, in representing the points that define the shapes in the tile in multiple format points, further defines the points relative to the reference pair in multiple short integer format points.

49. The system of claim 44 wherein the processor, in representing the points that define the shapes in the tile in multiple format points, further defines the points in one of a range of sizes from less than a byte to about eight bytes.

50. A system for representing and displaying geo-spatial data on a handheld device, the system comprising:
a display device;
a memory;
a user input device; and
a processor programmed to:
store the geo-spatial data in a data file in the memory,
receive a location point used to retrieve the geo-spatial data associated with the location point from the user input device,
determine whether the location information is contained within a bounding box that encloses a shape stored in the memory,
retrieve from the memory a first shape description if the location information is contained within the bounding box,
display a first vector shape associated with the first shape description on the display device,
repeatedly display the bitmap with the first vector shape to fill in the interior of the displayed first vector shape if the interior of the first vector shape is to be filled in on the display device,
retrieve from the memory a second shape description if the first vector shape has a pointer to a second vector shape, and
display the second vector shape associated with the second shape description within the first vector shape on the display device.

51. The system of claim 50 wherein the processor, in storing the geo-spatial data in the data file in memory, is further programmed to:
divide the geo-spatial data into multiple tiles;
assign a reference pair to a tile;
represent points that define shapes in the tile in multiple format points; and
display and position the tile next to another tile based on the reference pair assigned to both tiles on the display device.

52. The system of claim 51 wherein the processor, in assigning the reference pair to the tile, further defines a coordinate point on the tile, wherein the coordinate point describes a location of the tile in the geo-spatial data and is stored as two double-precision floating-point numbers.

53. The system of claim 51 wherein the processor, in representing points that define the shapes in the tile in multiple format points, further defines points describing shapes relative to the reference pair in multiple short integer format points.

54. The system of claim 51 wherein the processor, in representing points that define shapes in the tile in multiple format points, further defines the points in one of a range of sizes from less than a byte to about eight bytes.

55. The system of claim 50 wherein the processor, in retrieving from the data file the first shape description, further determines whether the first shape description is one of an ellipse, a circle, a linear segment or a polygon.

56. The system of claim 50 wherein the processor, in displaying the first vector shape, is further programmed to:
display an ellipse based on four coordinate points that define four vertices of a bounding box that surround the ellipse and whose midpoints on each side of the bounding box coincide with one point on the ellipse.

57. The system of claim 50 wherein the processor, in displaying the first vector shape, is further programmed to:
display an ellipse based on four coordinate points that define four midpoints of a bounding box that surround the ellipse, wherein each midpoint coincides with one point on the ellipse.

58. The system of claim 50 wherein the processor, in displaying the first vector shape, is further programmed to:
display a circle based on a coordinate point that defines a center of the circle and a scalar value that defines a radius of the circle, wherein the radius of the circle measures a distance from the center of the circle to any point along a circumference of the circle.

59. The system of claim 50 wherein the processor, in displaying the first vector shape, is further programmed to:
display a linear segment based on two coordinate points that define endpoints of an imaginary line that forms down a center of the linear segment and a scalar value that defines a width of the linear segment, wherein a perpendicular distance from any point on the imaginary line to an outline of the linear segment on either side of the imaginary line is one-half the width of the linear segment.

60. The system of claim 50 wherein the processor, in displaying the first vector shape, is further programmed to:
display a polygon based on a series of coordinate points that define each vertex of the polygon.

61. The system of claim 50 wherein the processor is further programmed to:
determine if the second vector shape is a lowest order shape in the geo-spatial data; and
retrieve from the data file a third shape description if the second vector shape has a pointer to a third vector shape.

62. The system of claim 50 wherein the processor is further programmed to determine if the second vector shape is a last shape in the geo-spatial data.
